(19) United States
(12) Patent Application Publication
(10) Pub. No.: US 2007/0090152 A1
(43) Pub. Date: Apr. 26, 2007

(54) Method for cladding the blade tips of rotor blades of a gas turbine power plant and device for carrying out the method

(75) Inventors: Reinhold Meier, Dorfen (DE); Mario Schmidt, Moers (DE)

Correspondence Address: KENYON & KENYON LLP, ONE BROADWAY, NEW YORK, NY, 10004, US

(73) Assignee: MTU AERO ENGINES GMBH, Munchen (DE)

(21) Appl. No.: 10/560,564

(22) PCT Filed: Jun. 4, 2004
(86) PCT No.: PCT/DE04/01158

§ 371 Date: Nov. 13, 2006

(30) Foreign Application Priority Data
Jun. 12, 2003 (DE) 103 26 541.4

(51) Int. Cl. A47J 36/02

(52) U.S. Cl. 228/101

(57) ABSTRACT

A method is for the cladding of blade tips of compressor blades of a gas turbine power plant, using a blank, which is made up of a solder foil provided with a metal layer having embedded hard particles and which is adapted to the geometry of the blade tip that is to be clad, which blank is melted onto the blade tip while applying pressure, and in the process obtains, impressed into it, a ribbed or pimpled structure.

### FIELD OF THE INVENTION

The present invention relates to a method and a device for carrying out the method for cladding the tips of rotor blades of a gas turbine power plant, using oxidation-resistant metal layers having embedded Al oxide particles, Si carbide particles, Cr oxide particles or similar hard particles.

### BACKGROUND INFORMATION

The gap present between the rotor blade tips and the associated intake coating present in modern gas turbine power plants is very tight, in order to keep the gap loss, that influences the efficiency, low, so that, during operation, as a result of prevalent thermal stresses and acting centrifugal forces, a brushing contact may occur of the blade tips and the intake coating. This leads to the blade tips cutting into the intake coating, which should, to the greatest extent possible, take place without wear and without great heating. It is known, in this connection, that one should develop the coatings on the stator side to be relatively soft (abradable) and on the rotor side relatively hard (abrasive) as so-called cladding.

Such cladding of the blade tips, as is commonly known, is applied by coating using metal spraying of carbides and/or oxides, by soldering on hard grains, or even by welding on hard materials.

### SUMMARY

An example embodiment of the present invention may provide a method for cladding such blade tips, which may make possible, in a simple fashion, a dimensionally correct cladding in a fail-safe manner.

According to an example embodiment of the present invention, a method includes applying the metal containing the embedded hard particles as a Co layer or an Ni layer onto a solder foil which, depending on the geometry of the blade tip that is to be clad, is cut to size as a blank, and, using a moving device that generates a pressure force, whose foil holder has a roughened surface, the blank, after inductive heating of the blade tip, is melted onto the latter while applying surface pressure.

However, the coating of the solder foil with a metallic layer including hard particles may also be performed by galvanic nickel coating, using dispersed hard particles.

The generation of the abrasive surface of the cladding may take place by having a ribbed or pimpled surface of the foil holder of the moving device generating the pressure force during the melting-on procedure, in which the ribbed of pimpled surface is impressed into the surface of the melted-on layer, the melting-on, e.g., taking place under a protective gas.

After the melting-on of the cladding onto the blade tips, excess solder may be mechanically removed from the clad blade tip.

A device for carrying out the method may include a foil holder having a roughened surface for accommodating a metallic blank having abrasive properties and by a rotor blade holder accommodating a rotor blade as part of a rotor of a gas turbine power plant having a device for the inductive heating of the tip of the clamped stator blade, the device being arranged such that, between the foil holder and the blade holder a predeterminable pressure force is able to be applied.

The method for cladding rotor blade tips may have a number of advantages. Thus, for example, if there is appropriate dimensioning of the length of the blade in the state ready for installation, one may omit a processing of the blade tips. The connection of the blade tip and the metallic layer may take place very rapidly, and the layer used for the cladding may have an optimum adherence, since a metallic connection is produced between it and the blade tip. As mentioned before, it may be possible to apply a dimensionally correct coating. As a result of the impressed grooved or pimpled surface of the metal layer, the structure of the surface may act in a cutting or piercing manner and, during application, it may prevent a great heat input into the rotor blade.

Example embodiments of the present invention are described in more detail below with reference to the appended figures.

### BRIEF DESCRIPTION OF THE DRAWINGS

FIG. 1 is a perspective view of a rotor blade of a rotor forming a part of a gas turbine power plant.

FIG. 2 is a partial cross-sectional view of a device for carrying out a method for cladding the tips of rotor blades illustrated in FIG. 1.

FIG. 3 illustrates a foil holder of the device illustrated in FIG. 2.

### DETAILED DESCRIPTION

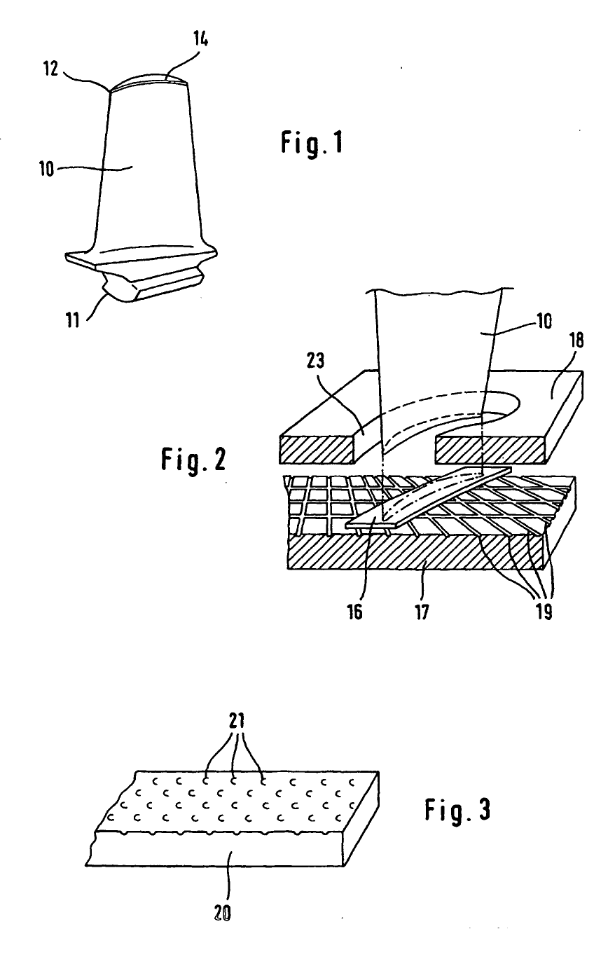

A rotor blade 10 of a rotor that is illustrated in FIG. 1 of a gas turbine power plant includes a blade root 11 and a blade tip 12, which is provided with an abrasively acting cladding 14. This cladding is made up of a metal layer that is resistant to oxidation and has embedded in it Al oxide particles, Si carbide particles, Cr oxide particles or similar hard particles, etc.

In order to apply this cladding to blade tip 12 of the rotor blade of the rotor, a metal containing the embedded hard particles is applied as a Co layer or an Mn layer onto a solder foil, which is cut to size corresponding to the geometry, of the blade tip that is to be clad, and is laid down as blank 16 (cf. FIG. 2) onto a foil holder 17 of a device that is only partially shown illustrated. The foil holder is provided with a roughened surface, for example, in the form of geometrically arranged grooves 19, as illustrated in FIG. 2, or of geometrically arranged pimples 21 in foil holder 20, as illustrated in FIG. 3.

Each rotor blade 10 that is to be furnished with cladding 14 is individually mounted in a blade holder 18 and is guided there in a recess 23, to be movable back and forth. Via the blade holder, the rotor blade is lowered onto blank 16 that lies upon foil holder 17, and in this process it is heated using induced high frequency current. When the working temperature of the solder foil is attained, the foil holder is pressed with pressure force against tip 12 of the rotor blade that is clamped in the rotor blade holder, so that, when the metal that includes the embedded hard particles is melted onto the blade tip, the groove pattern or the pimple pattern is impressed into the latter.

The melting takes place under protective gas, and convention equipment may be used for this is.

After taking out the rotor blade, now having the clad tip, from the blade holder, excess solder and coating are mechanically removed.

Instead of cladding a solder foil using a Co metal layer or an Mn metal layer having embedded hard particles, the solder foil that is to be processed to form blanks 16 may also be provided by galvanic or nickel plating with the metal layer containing the embedded hard particles in dispersed form.

1-6. (canceled)

7. A method for cladding a tip of a rotor blade of a gas turbine power plant, comprising:
cutting a solder foil to size as a blank in accordance with a geometry of the tip;
applying a metal including embedded at least one of (a) Al oxide particles, (b) Zr oxide particles, (c) Cr oxide particles and (d) other hard particles as one of (a) a Co layer and an Ni layer onto the solder foil; and
melting the blank onto the tip while applying surface pressure after inductive heating of the tip with a moving device that generates a pressure force and that includes a foil holder having a roughened surface.

8. The method according to claim 7, wherein the metal is applied to the solder foil in the applying step by nickel plating.

9. The method according to claim 7, wherein the metal is applied to the solder foil in the applying step by galvanic plating.

10. The method according to claim 7, wherein the melting is performed under a protective gas.

11. The method according to claim 7, further comprising impressing one of (a) a ribbed surface structure and (b) a pimpled surface structure onto the blank.

12. The method according to claim 7, further comprising mechanically removing excess solder and cladding after the melting step.

13. A device, comprising:
a foil holder having a roughened surface adapted to accommodate a metallic blank having abrasive properties;
a rotor blade holder adapted to accommodate a rotor blade as a part of a rotor of a gas turbine power plant; and
an inductive heating device adapted to heat a blade tip and to apply a predeterminable pressure force between the foil holder and the blade holder.
